(19) United States
(12) Patent Application Publication
(10) Pub. No.: US 2011/0287217 A1
(43) Pub. Date: Nov. 24, 2011

(54) SUPEROLEOPHOBIC SUBSTRATES AND METHODS OF FORMING SAME

(76) Inventors: Prantik Mazumder, Ithaca, NY (US); Robert S. Wagner, Corning, NY (US)

(21) Appl. No.: 12/784,955

(22) Filed: May 21, 2010

(51) Int. Cl. B32B 3/00; C03C 23/00

(52) U.S. Cl. 428/141; 264/400

(57) ABSTRACT

Superoleophobic substrates and methods of forming same are disclosed. The methods include providing a laser-ablatable substrate comprising glass and directing a laser beam to the substrate surface and laser-ablating at least a portion thereof to form an array of spaced-apart micropillars having sidewalls. The laser beam is provided with sufficient energy to form on the sidewalls an irregular rough surface with re-entrant microscale and nanoscale features that render the substrate surface superoleophobic when coated with a low-surface-energy coating.

### FIELD

This disclosure generally relates to non-wetting substrates, and in particular to superoleophobic substrates and methods of forming same.

### BACKGROUND

There is presently great interest in developing non-wetting substrates through surface chemistry and surface texturing. A surface repellant to water and/or an organic fluid (e.g., oil) has utility for a variety of applications relating to, for example, micro-fluidics, micro-electrical mechanical systems (MEMS), micro-separation, hand-held devices, medical devices, touch screens and the like.

The non-wetting characteristic of a substrate is usually classified in terms of the static contact angle (θ) of a small liquid droplet placed on the substrate. If the liquid is water, then the substrate is regarded as hydrophilic or hydrophobic if the water contact angle θ_{CW} is less than or greater than 90°, respectively. Similarly for oil, the substrate is regarded as oleophilic or oleophobic if the oil contact angle θ_{CO} is less than or greater than 90°, respectively.

Surface roughness and microstructures can be formed on a substrate to make it more hydrophobic. Moreover, because a perfectly flat surface is inherently oleophilic, one needs to use a roughened or microstructured surface to make a substrate oleophobic.

A special class of hydrophobic substrates is the super-hydrophobic substrate for which the water contact angle θ_{CW}>150°. Likewise, a special class of oleophobic substrates is the superoleophobic substrate for which the oil contact angle θ_{CO}>150°. It has proven difficult to form superoleophobic substrates because the surface tensions of oil and organic liquids are relatively low. This causes the liquid to invade the spaces of most types of roughened or microstructured substrate surfaces. Unfortunately, identifying and forming the specialized substrate surface features that render a substrate superoleophobic is a time-consuming and expensive endeavor.

### SUMMARY

An aspect of the disclosure is a method of forming a superoleophobic surface. The method includes providing a laser-ablatable substrate having a surface, with the substrate comprising glass. The method also includes directing a laser beam to the substrate surface and laser-ablating at least a portion of the substrate surface to form an array of spaced-apart micropillars having sidewalls, including providing the laser beam with sufficient energy to form on the sidewalls an irregular rough surface with re-entrant microscale and nanoscale features that render the substrate surface superoleophobic when coated with a low-surface-energy coating. The method further includes coating the substrate surface with the low-surface-energy coating.

Another aspect of the disclosure includes the method as described above, and further comprising generating debris from the laser-ablated portion of the substrate surface during the laser-ablating, and allowing the debris to deposit on and affix to the micropillar sidewalls.

Another aspect of the disclosure includes one or more of the methods as described above, and further comprising performing the laser ablating by irradiating the substrate surface with pulses of laser radiation.

Another aspect of the disclosure includes one or more of the methods as described above, and further comprising directing the laser pulses to the substrate surface with a scanning mirror and an F-theta lens.

Another aspect of the disclosure includes one or more of the methods as described above, and further comprising at least one of moving the laser beam and moving the substrate.

Another aspect of the disclosure includes one or more of the methods as described above, wherein the micropillars are not cylindrical.

Another aspect of the disclosure includes one or more of the methods as described above, wherein the superoleophobic substrate surface defines at least one of a) a water contact angle θ_{CW} for a water droplet such that 115°≦θ_{CW}≦180°, and b) an oil contact angle θ_{CO} for an oil droplet such that 75°≦θ_{CO}≦180°.

Another aspect of the disclosure includes one or more of the methods as described above, wherein the micropillars do not have an overhang.

Another aspect of the disclosure includes one or more of the methods as described above, and further comprising laser-ablating the substrate surface portion in a pattern that forms an X-Y grid of grooves in the substrate surface portion.

Another aspect of the disclosure is a method of converting a substrate surface to a superoleophobic substrate surface. The method includes providing a substrate having the substrate surface, the substrate being formed from glass. The method also includes selecting a pattern for laser-ablating at least a portion of the substrate surface, wherein the pattern corresponds to an array of micropillars that would not render the substrate surface superoleophobic when coated with a low-surface-energy coating. The method additionally includes laser-ablating the substrate surface in accordance with the selected pattern to form an actual array of micropillars having sidewalls, while also generating debris from the laser-ablated substrate portion. The method further includes allowing the debris to deposit on and affix to the micropillars to form an actual array of micropillars having sidewalls with an irregular rough surface with re-entrant microscale and nanoscale features that render the substrate surface superoleophobic when coated with a low-surface-energy coating. The method also includes coating the substrate surface with the low-surface-energy coating.

Another aspect of the disclosure includes the surface-converting method as described above, wherein the substrate surface defines an oil contact angle θ_{CO} for a drop of oil such that 75°≦θ_{CO}≦180°.

Another aspect of the disclosure includes one or more of the surface-converting methods as described above, and further comprising performing the laser ablating by irradiating the substrate surface with pulses of laser radiation.

Another aspect of the disclosure includes one or more of the surface-converting methods as described above, and further comprising at least one of a) scanning the laser pulses over the substrate surface using a scanning mirror and an F-theta lens, and b) moving the substrate.

Another aspect of the disclosure includes one or more of the surface-converting methods as described above, wherein the low-surface-energy coating comprises at least one of fluoropolymer and fluorosilane.

Another aspect of the disclosure includes one or more of the surface-converting methods as described above, wherein the superoleophobic substrate surface further defines a water contact angle θ_{CW} such that 115°≦θ_{CW}≦180°.

Another aspect of the disclosure is a superoleophobic substrate, wherein the substrate has a surface and comprises glass. The superoleophobic substrate includes a laser-ablated substrate portion comprising an array of spaced-apart micropillars formed in the surface and having sidewalls. The sidewalls have an irregular rough surface as a result of the laser ablation, with re-entrant microscale and nanoscale features that render the substrate surface superoleophobic when the substrate surface is coated with a low-surface-energy coating. The superoleophobic substrate also includes the low-surface-energy coating on the substrate surface.

Another aspect of the disclosure is the superoleophobic substrate as described above, wherein the irregular rough surface includes laser-ablation debris deposited on and affixed to the sidewalls.

Another aspect of the disclosure is the superoleophobic substrate as described above, wherein the superoleophobic substrate surface defines at least one of a) a water contact angle θ_{CW} for a water droplet such that 115°≦θ_{CW}≦180°, and b) an oil contact angle θ_{CO} for an oil droplet such that 75°≦θ_{CO}≦170°.

Another aspect of the disclosure is the superoleophobic substrate as described above, wherein the low-surface-energy coating comprises at least one of fluoropolymer and fluorosilane.

Another aspect of the disclosure is the superoleophobic substrate as described above, wherein the re-entrant microscale and nanoscale features includes bumps on and pits in the micropillar sidewalls.

It is to be understood that both the foregoing general description and the following detailed description present embodiments of the disclosure, and are intended to provide an overview or framework for understanding the nature and character of the disclosure as it is claimed. The accompanying drawings are included to provide a further understanding of the disclosure, and are incorporated into and constitute a part of this specification. The drawings illustrate various embodiments of the disclosure and, together with the description, serve to explain the principles and operations of the disclosure. In some of the Figures, Cartesian coordinates are shown for reference.

### DESCRIPTION OF THE DRAWINGS

FIG. 1 is a close-up, cross-sectional view of an example substrate having a smooth surface with a drop of liquid formed thereon;

FIG. 2 is a schematic isometric view of an example substrate where the otherwise flat surface is artificially roughened by an array of micropillars;

FIG. 3A and FIG. 3B are close-up cross-sectional views of an example substrate having micropillars and that show a drop of liquid in the Wenzel state (FIG. 3A) and in the Cassie-Baxter state (FIG. 3B);

FIG. 4A (for water) and FIG. 4B (for oil) respectively plot the calculated contact angle θ_{Y} (degrees) versus the ratio b/a according to the Wenzel and Cassie-Baxter models based on the substrate with the micropillar array shown in FIG. 2;

FIG. 5 is close-up cross-sectional view of an example substrate similar to that of FIGS. 3A and 3B, and that illustrates the partial invasion of a meniscus of the liquid into the interpillar spaces to a penetration depth h;

FIG. 6 plots the free energy (left-hand axis, dashed line) versus the normalized penetration depth h/H for the composite state, and also plots the corresponding contact angle θ in degrees (right-hand axis, solid line) as function of the normalized penetration depth for oil;

FIG. 7A and FIG. 7B are close-up cross-sectional views of the substrate surface of FIG. 2, wherein the liquid drop in FIG. 7A is water and in FIG. 7B is oil;

FIGS. 8A through 8C are similar to FIG. 7A and illustrate examples where the micropillars are in the form of inverted pyramids;

FIG. 9 is a schematic diagram of an example laser ablation system of the present disclosure used to form a superoleophobic substrate;

FIG. 10 illustrates three examples (EX1, EX2 and EX3) of scanning the laser spot over the substrate with different stepping distances;

FIG. 11 illustrates an example scanning pattern for the light spot that generates Y-direction grooves in the substrate;

FIG. 12 is a close-up cross-sectional view of an comparative example of a micropillar array;

FIG. 13 is a close-up view of a substrate as the laser ablation system directs the laser beam to scan the laser spot over the substrate surface to start forming grooves therein;

FIG. 14A is a schematic cross-sectional view of an actual micropillar array as formed in the superoleophobic substrate by the laser ablation process, illustrating how the form of the actual micropillar array departs substantially from the idealized micropillar array of FIG. 12;

FIG. 14B is similar to FIG. 14A and shows the addition of a low-surface-energy coating on the substrate surface;

FIG. 15 and FIG. 16 are top-down perspective scanning confocal microscope images of an example superoleophobic substrate and the micropillar array taken at different magnifications, where the micropillar array was formed via laser ablation with the laser ablation system of FIG. 9;

FIGS. 17A through 17C are cross-sectional images of actual micropillars formed via laser ablation, shown with increasing magnification from FIG. 17A to FIG. 17C, and illustrating the resultant irregular rough surface with re-entrant microscale and nanoscale features;

FIG. 18 plots the measured contact angle (degrees) for water (squares) and oil (circles) as a function of feature size (microns) on superoleophobic substrates fabricated by the laser ablation methods of the present disclosure; and

FIG. 19 is a top-down view of an example substrate that includes at least one superoleophobic region formed using laser ablation, and that also includes at least one region that is other than superoleophobic.

### DETAILED DESCRIPTION

Reference is now made in detail to embodiments of the disclosure, examples of which are illustrated in the accompanying drawings. Whenever possible, the same or like reference numbers are used throughout the drawings to refer to the same or like parts. In the discussion below, the symbol “˜” means “approximately.” Also, the term “micropillars” does not necessarily imply a micron-scale, but rather indicates that the micropillars are very small relative to a liquid droplet, and can have a nanometer scale, a micrometer scale, a millimeter scale, and combinations thereof.

### Contact Angles

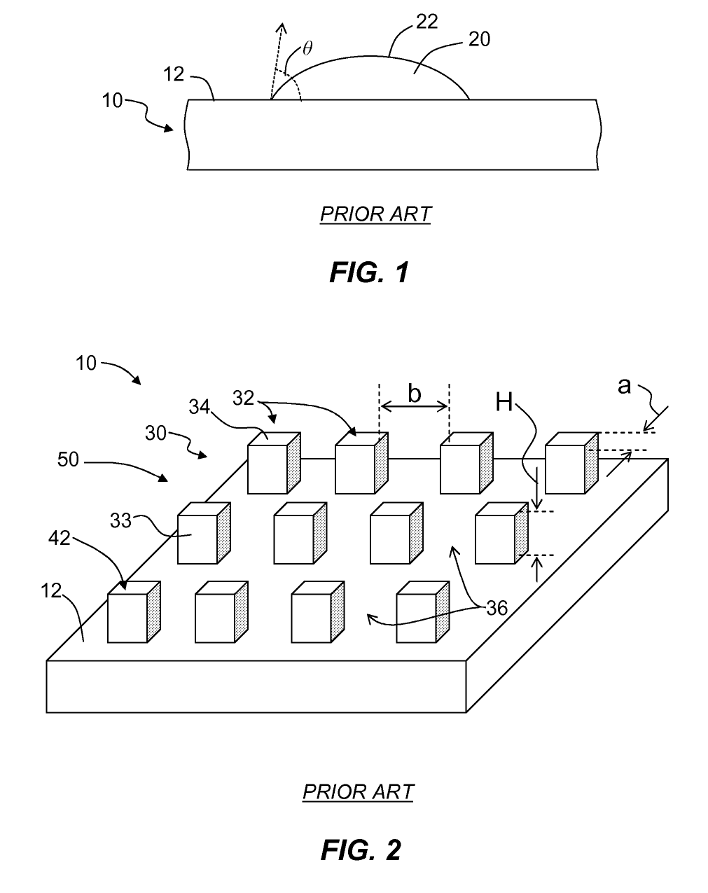

FIG. 1 is a close-up, cross-sectional view of an example substrate 10 having a smooth surface 12 with a drop of liquid 20 formed thereon. Liquid 20 has a liquid surface 22. Liquid 20 can be water or an organic substance such as oil. Liquid 20 forms a contact angle θ with surface 12 that depends on the substrate surface energy and the surface roughness. If surface 12 is perfectly smooth, then the contact angle θ depends only on the substrate surface energy, and the static contact angle is determined by the Young force balance condition at the triple line as:

$$cos {θ}_{Y} = \frac{{γ}_{SV} - {γ}_{SL}}{{γ}_{LV}} \qquad ( 1 )$$

where θ_{Y} is the Young contact angle, i.e., the contact angle on a perfectly smooth (flat) substrate surface, γ_{SV} is the surface energy of the solid-vapor interface, γ_{SL} is the interfacial energy between the liquid and solid, and γ_{LV} is the liquid-vapor surface energy, also known as the surface tension of the liquid in the atmosphere of a specific vapor phase.

From equation (1), it is observed that a very low value of γ_{SV} or surface energy of the solid surface is required to produce a super non-wetting condition on a perfectly flat surface 12. The maximum water and oil contact angles θ_{CW} and θ_{CO} obtained on flat surfaces 12 of natural and synthetic substrates 10 are respectively θ_{CW}˜120° and θ_{CO}˜70° to 80°. There is no naturally occurring or synthetically made material that is super-hydrophobic without any surface roughness. In the case of oil, the situation is even more challenging, as there is no naturally occurring or synthetically made material that is oleophobic, let alone superoleophobic, in the absence of surface roughness.

It is known that surface roughness can enhance the wetting and/or non-wetting characteristics of a substrate. An example of naturally occurring super-hydrophobic surfaces is the lotus leaf, having a water contact angle θ_{CW} of as high as 170°. This super-hydrophobicity is ascribed to both surface chemistry and surface roughness. Many super-hydrophobic surfaces have been fabricated based on information learned from such naturally occurring surfaces.

### Example Artificially Roughened Substrate

FIG. 2 is a schematic isometric view of an example substrate 10 where the otherwise flat surface 12 is artificially roughened by an array 30 of micropillars 32 that protrude from the substrate surface. Micropillars 32 have sidewalls 33 and an upper surface 34 that generally defines an upper substrate surface 42, while surface 12 constitutes a lower, smooth substrate surface. Thus, substrate 10 has a composite surface collectively referred to as surface 50. Micropillars 32 in FIG. 2 are shown as having a square cross-sectional shape and a flat upper surface 34. Array 30 is defined by three main parameters: the micropillar side-dimension a, interpillar spacing b (thereby defining interpillar spaces 36), and micropillar height H. By controlling these parameters, the substrate roughness characteristics can be controlled. The typical dimensions of a, b and H as considered in the present disclosure are generally nanometer-scale to millimeter scale. By way of example, a can be on the order of 1 to 500 microns, b can be on the order of 1 to 50 microns and H can be on the order of 100 nm to 500 microns. Generally, micropillars 32 are configured so that liquid droplet 20 is much larger than the surface roughness presented by micropillar array 30.

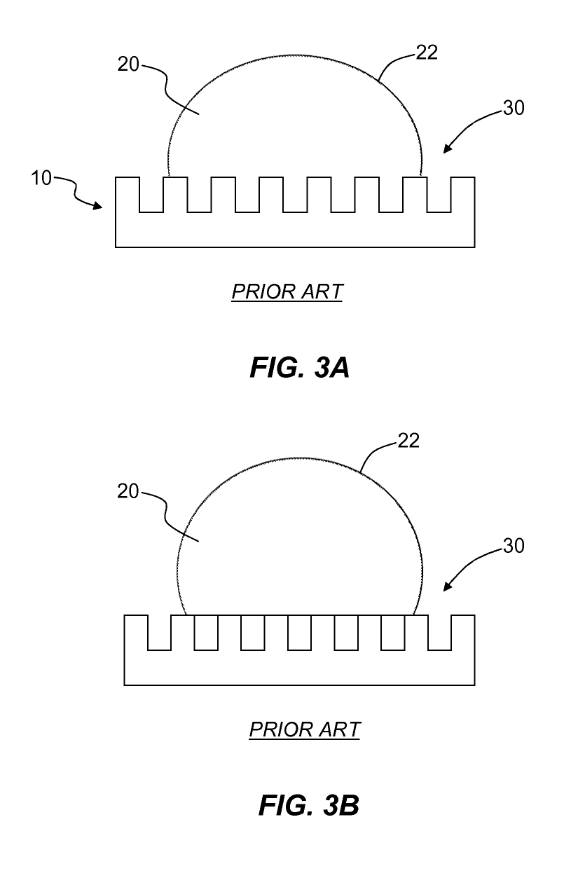

It has been observed and theoretically predicted that when liquid droplet 20 is placed on a roughened substrate 10 such as that shown in FIG. 2, it can assume two configurations: the Wenzel state or the Cassie-Baxter state. FIG. 3A is a cross-sectional view of substrate 10 illustrating a droplet of liquid 20 in the Wenzel state, and FIG. 3B is similar to FIG. 3A and shows the liquid droplet in the Cassie-Baxter state. In the Wenzel state, liquid 20 fully invades interpillar spaces 36 so that the lower substrate surface 12 underneath the liquid droplet is wetted. The contact angle θ_{W} in the Wenzel state is given by the well-established Wenzel model:

cos θ_{W}=r_{W} cos θ_{Y} (2)

where r_{W} is a roughness parameter defined as the ratio between the actual wetted area and the projected planar area and is therefore is always greater than one. A direct consequence of this model is that if the original substrate 10 is non-wetting to liquid 20, the roughened surface 50 is even more non-wetting to the same liquid. Stated differently, if the flat surface Young contact angle θ_{Y} is greater than 90°, then the contact angle on the rough surface is even greater than the Young contact angle θ_{Y}.

A super-hydrophobic state is thus possible to achieve by creating a surface roughness on an intrinsically hydrophobic substrate, such as PTFE or DC2604. However, another direct consequence of this model is that if the original substrate 10 is wetting to liquid 20, roughened surface 50 is even more wetting to the liquid (or, if the Young contact angle θ_{Y}<90°, then the contact angle on the rough surface is even lower than θ_{Y}). In the case of oil, a non-oleophobic state cannot be made on any substrate 10 as long as oil droplet 20 assumes the Wenzel state. This is because there is no known material for which the Young contact angle θ_{Y}>90° for oil.

However, liquid droplet 20 can also assume the Cassie-Baxter configuration of FIG. 3B. In this configuration, liquid droplet 20 sits atop upper substrate surface 42 without invading interpillar spaces 36. This configuration state is also known as the “composite state,” since a composite interface of liquid-solid and liquid-air coexists to create the overall interface shape. In this case, a very large contact angle θ can be attained if much of the liquid surface 22 can be suspended in air.

The contact angle θ_{CB} in the Cassie-Baxter state is expressed as:

COS θ_{CB}=−1+f(1+r_{f} cos θ_{Y}) (3)

where f is the fraction of solid-liquid interface and r_{f} is the roughness factor of the wetted area. It is observed from equation (3), as well as from physical considerations, that the lower the value of solid-liquid area fraction f, the higher the contact angle θ_{CB}. In the extreme case of f=0, the situation corresponds to a liquid droplet suspended in air, which corresponds to a contact angle of θ=180°, and in the other extreme case of f=1, the configuration state corresponds to the fully wetted Wenzel state. Simple geometric structures akin to array 30 with micropillars 32 composed of square posts, cylinders, cones etc., have been created to form a super-hydrophobic surface with θ_{CB}>150° starting with substrates on which the Young contact angle θ_{Y}>90°.

While examples of artificially created super-hydrophobic surfaces exist in the literature, essentially all were fabricated by painstakingly complicated and/or slow processes such as photolithography and electrochemical etching. A fundamental reason why it is difficult to create an oleophobic substrate is that the surface tension of oil and other organic liquids is very low (˜20-40 dynes/cm). There is no known material, natural or synthetic, wherein θ_{Y}>90° for oil on flat surface. This means that all perfectly flat surfaces are olcophilic. Therefore, one has no choice but start with an initially oleophilic surface and convert it to oleophobic and/or superoleophobic substrate.

It has been theoretically and experimentally shown that the Cassie-Baxter state (FIG. 3B) on regular geometric surfaces is unstable if θ_{Y}<90°. The general rule of thumb on such structures is: (1) if θ_{Y}>90° (such as for water), then the Cassie-Baxter state is either metastable or stable depending on the design parameters (such as a, b and H of FIG. 2); and (2) if θ_{Y}<90° (such as for oil), then the Cassie-Baxter state is unstable.

Since for oil θ_{Y}<90° (with the maximum being ˜80°), it is difficult to achieve the Cassie-Baxter state on simple rough surfaces such as that shown in FIG. 2 and FIG. 3B. This is because there is a natural tendency for oil droplet 20 to invade the interpillar spaces 36 and transition into the Wenzel state. This transition from the Cassie-Baxter state to the Wenzel state is known as the “wetting transition.” As discussed above, if θ_{Y}<90°, then the contact angle θ_{W} in the Wenzel state will be even smaller than the Young contact angle θ_{Y}. Therefore, this poses a serious challenge to create oleophobic, let alone superoleophobic, substrates through surface roughening.

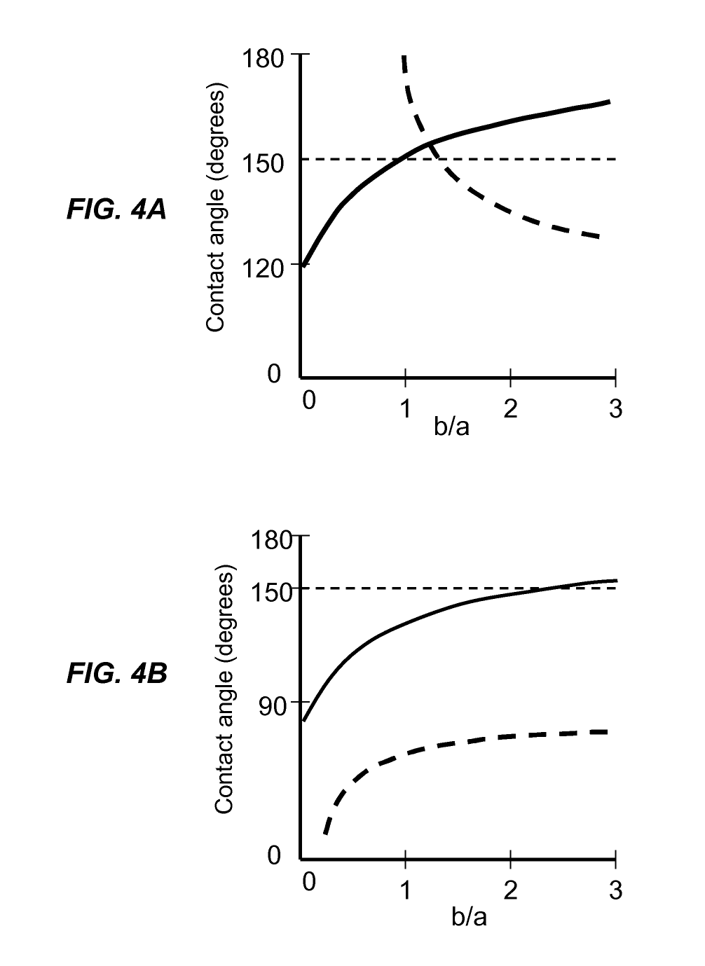

FIG. 4A and FIG. 4B respectively plot the calculated contact angle θ (degrees) versus the ratio b/a according to the Wenzel (W) and Cassie Baxter (CB) models based on a rough surface 50 formed by array 30 of square micropillars 32, as shown in FIG. 2. FIG. 4A corresponds to water with an initial Young contact angle θ_{Y}=120°, whereas FIG. 4B corresponds to oil with an initial Young contact angle θ_{Y}=75°. These values are for substrates coated with a low-surface-energy coating of DC2604. In the plots of FIG. 4A and FIG. 4B, the solid curves correspond to the composite (Cassie-Baxter) state while the dashed curves correspond to the Wenzel state.

In the case of water, roughness increases the contact angle θ beyond the initial Young contact angle θ_{Y}, irrespective of whether liquid droplet 20 is in Wenzel state or Cassie-Baxter state. This can be seen in the plot of FIG. 4A, where all contact angle values are greater than 120°. This suggests that it is possible to achieve a super-hydrophobic state in both the Wenzel and Cassie-Baxter states. On the other hand, in the case of oil, the only way to achieve a contact angle θ higher than the initial Young contact angle θ_{Y} is to have the oil droplet in the Cassie-Baxter state. The Wenzel state contact angle θ_{W} is always lower than the initial Young angle θ_{Y} and slowly approaches the Young angle at the limit of very high b/a ratio, where a large b/a is similar to a flat surface. From the plot of FIG. 4B, it is seen that the b/a ratio has to be equal to or greater than ˜2 for the superoleophobic state to occur.

For any b/a ratio, the state with lower contact angle θ has a lower surface free energy. In the case of water, the Cassie-Baxter state has lower contact angle θ than the Wenzel state for b/a less than ˜1.25 in this particular example. Therefore, the Cassie-Baxter state is more stable than the Wenzel state in this regime, and a stable super-hydrophobic substrate in the Cassie-Baxter state could be created that will not transition into the Wenzel state. On the other hand, in the case of oil, the Wenzel state contact angle θ_{W} is always much lower than the Cassie-Baxter state contact angle θ_{CB}. The Cassie-Baxter state is therefore always at a much higher energy state that the Wenzel state. This means the Cassie Baxter state is inherently unstable and liquid 20 will have a natural tendency to invade interpillar spaces 36 and transition into the Wenzel state.

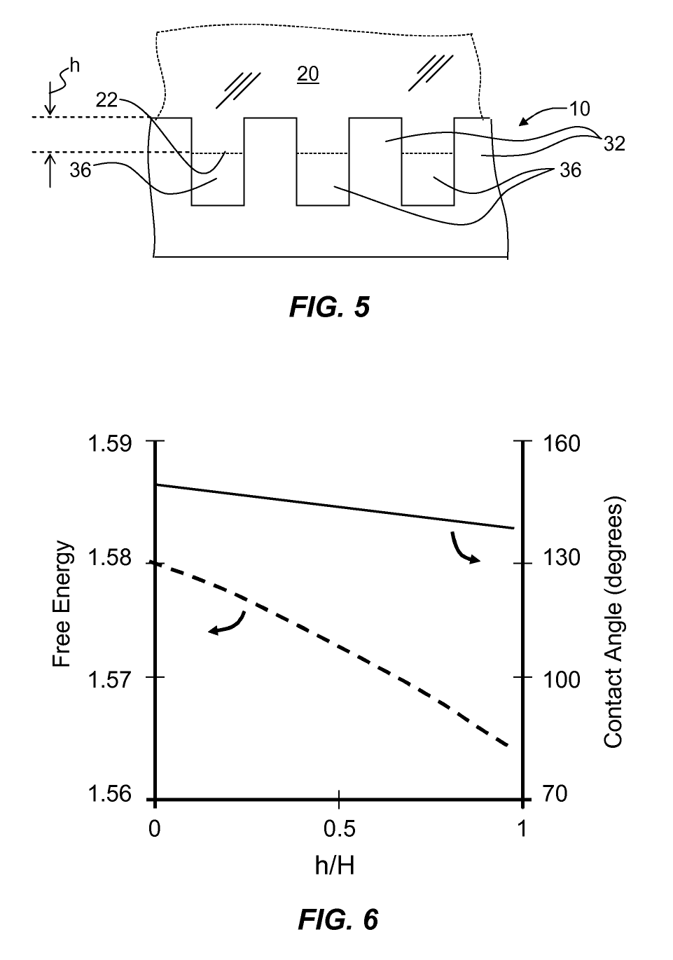

FIG. 5 is close-up cross-sectional view of an example substrate 10 similar to that of FIGS. 3A and 3B, and illustrates the invasion of a meniscus 24 of liquid 20 by a depth h into the interpillar spaces 36, which are assumed to be occupied by air. The Cassie-Baxter state corresponds to the case of zero penetration depth, or h=0. However, a composite state can exist even for non-zero value of h, as long as h<H.

FIG. 6 plots the free energy (left-hand axis and dashed line) versus the normalized penetration depth h/H for the composite state and also plots the corresponding contact angle θ (right-hand axis and solid line) as function of the normalized penetration depth for oil. As can be seen in FIG. 6, the free energy of the system decreases monotonically as the penetration depth h increases, thereby suggesting an unstable system for oil. In this case, an oil liquid drop 20 will spontaneously invade and flood the interpillar spaces 36 leading to a transition to the Wenzel state. It is also seen from the plot of FIG. 6 that the overall oil contact angle θ_{CO} monotonically decreases with the penetration depth h.

The physics of the collapse of the composite interface to the wetting configuration can be understood by the role of the shape of liquid meniscus 24. While the effective contact angle θ of liquid droplet 20 on rough surface 50 is different from the Young contact angle θ_{Y}, the local contact angle satisfies the Young contact angle condition. This means the local contact angle θ of meniscus 24 on the vertical micropillar sidewalls 33 is equal to the Young contact angle θ_{Y}.

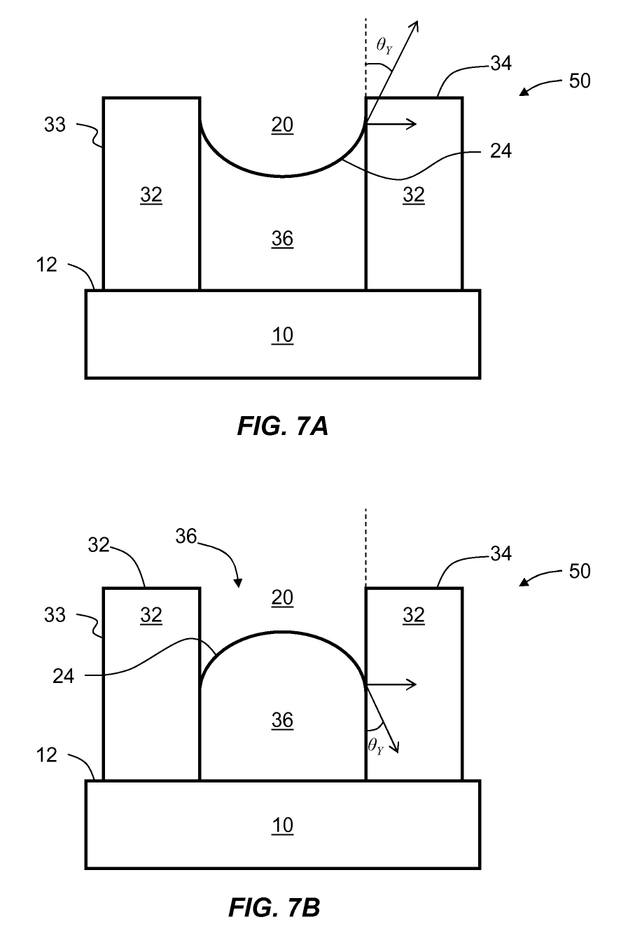

FIG. 7A and FIG. 7B are close-up cross-sectional views of the roughened surface 50 of FIG. 2, wherein the liquid drop 20 in FIG. 7A is water and in FIG. 7B is oil. In both FIG. 7A and FIG. 7B, meniscus 24 of liquid drop 20 has partially invaded interpillar spaces 36. Meniscus 24 is concave upwards for water and concave downwards for oil since the Young angles θ_{Y} are 120° and 75°, respectively. The vertical component of the surface tension force is therefore directed upwards in the case of water (FIG. 7A) and is directed downwards in the case of oil (FIG. 7B). This leads to an upward balancing force in the case of water that prevents its invasion into interpillar spaces 36. In the case of oil, there is an unbalanced downward pull on the interface that assists the invasion of oil into interpillar spaces 36.

This is the fundamental reason why a superoleophobic substrate requires a highly complex roughened surface 50 having, for example, an overhang, a re-entrant or a fractal surface geometry. These complex surface geometries are needed to prevent the invasion of interpillar spaces 36 by oil 20. A re-entrant or overhang geometry is where the roughness height above the lower substrate surface 12 is a multi-valued function of the lateral distance.

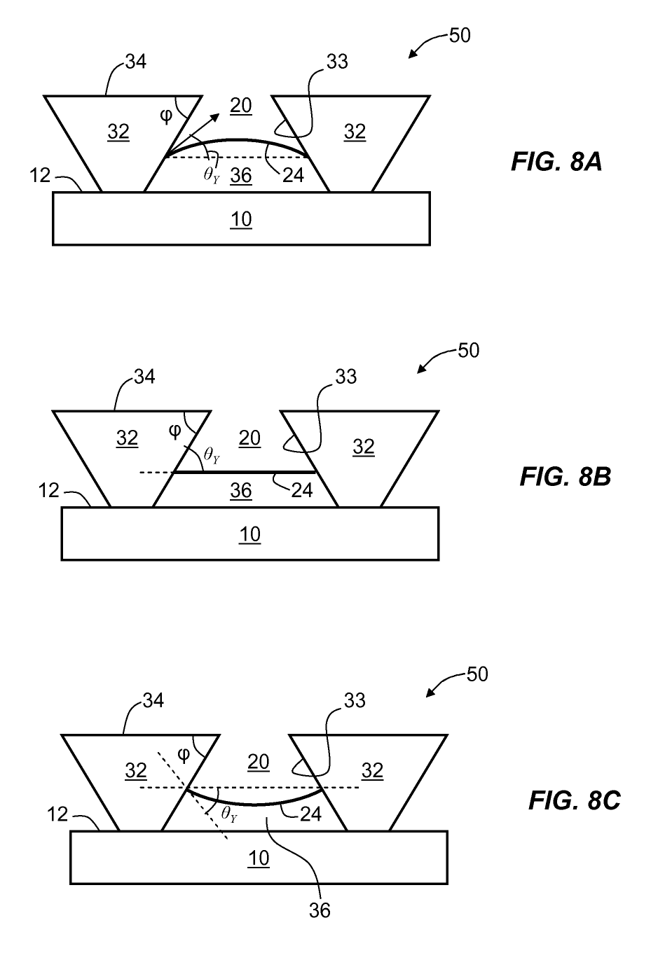

FIG. 8A through FIG. 8C are similar to FIG. 7A and FIG. 7B and illustrate examples of micropillars 32 in the form of inverted pyramids. This type of overhang structure represents the most basic form of a re-entrant geometry for micropillars 32. For an inverted pyramidal micropillar 32, at a particular location along the substrate underneath the micropillar, there are two different height values. An angle φ is defined by the intersection of upper surface 34 and sidewalls 33. The size of angle φ has a strong effect on the shape of meniscus 24 and therefore the invasive characteristic of liquid 20. For example, if φ>θ_{Y}, then meniscus 24 is concave downwards, as illustrated in FIG. 8A, and the surface tension force assists the liquid invasion of the interpillar spacing 36. If φ=θ_{Y}, then meniscus 24 is perfectly flat, as illustrated in FIG. 8B, and no vertical force is exerted on the meniscus. Finally, if φ<θ_{Y}, then meniscus 24 is concave upwards, as illustrated in FIG. 8C, and the surface tension force prevents the liquid invasion of the interpillar spaces 36.

For a stable composite state, the meniscus configurations of FIG. 8B and FIG. 8C are desired. Thus, a meta-stable superoleophobic substrate 10 can be designed by forming roughened surface 50 to have micropillars 32 with re-entrant features. Since the Young contact angle for oil on a fluorinated flat surface is θ_{Y}˜70-80°, then the re-entrant/overhang micropillars 32 of FIGS. 8A through 8C must have an angle φ smaller than ˜70-80°. While the Wenzel state is still the state of global minimum energy, an energy barrier around the composite state can be created by a re-entrant geometry to prevent the otherwise spontaneous wetting transition.

It is widely believed that an oleophobic substrate must have a re-entrant/overhang structure. This imposes tremendous restriction on the choice of surface geometries and the process for forming them because re-entrant surface geometries are difficult to fabricate. It is particularly difficult to mass produce such surfaces.

### Laser Ablation System

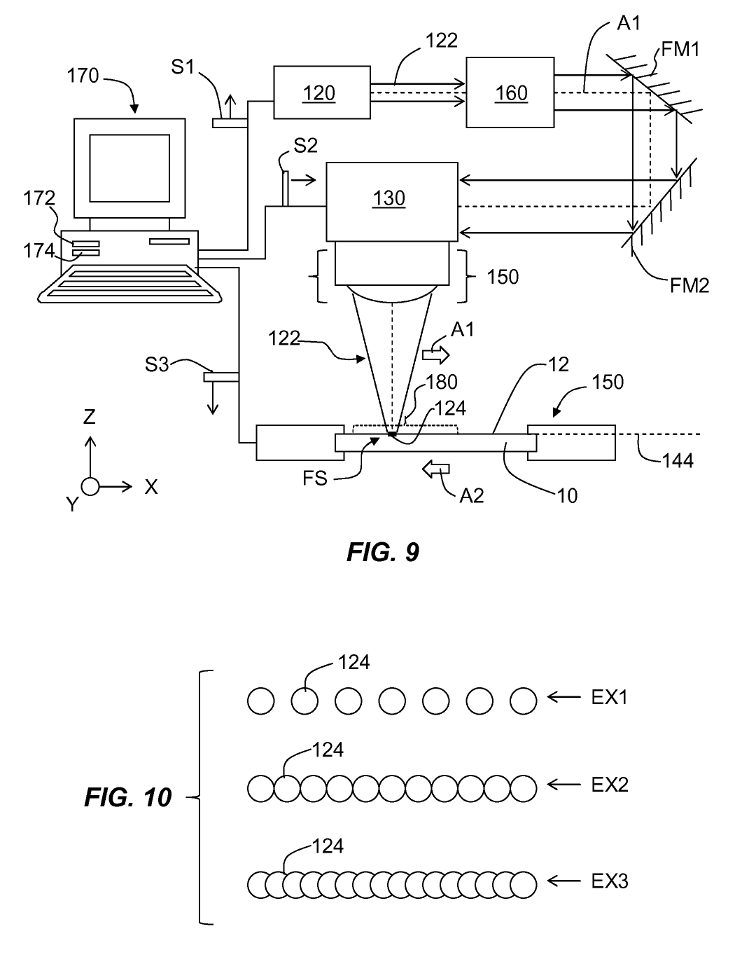

FIG. 9 is a schematic diagram of an example laser ablation system 100 used in the present disclosure to process an initial substrate 10 to form a superoleophobic substrate 110. Substrate 10 is generally laser-ablatable, and glass is an example material for the substrate. Here, a glass is defined as an amorphous (non-crystalline), solid material. Glass, as used herein, may be a glass article, or a layer of glass applied to the surface of another material. For example, a layer of glass may be applied to another material such as a metal or a ceramic, by sputtering, for example. This layer of glass may then be laser ablated according to embodiments of the present disclosure to form a superoleophobic substrate. If the glass is a layer of glass, the layer of glass must be at least as thick as the depth of the laser ablation. For example, the glass may be, for example, 30 μm thick, 40 μm thick, 50 μm thick, greater than 30 μm thick, greater than 40 μm thick, greater than 50 μm thick or the like. A ceramic is defined as an inorganic, non-metallic solid having a crystalline or partly crystalline structure.

System 100 includes a laser 120 that generates a laser beam 122. Laser 120 is optically coupled to a scanning system 130, which in turn is optically coupled to a scanning lens 140 having a focus FS and an image plane 144. A substrate stage 150 is arranged to support substrate 10 at image plane 144. Laser 120, scanning system 130 and substrate stage 150 are electrically connected to a controller 170. In an example, a magnifying lens 160 may be optionally included in the optical path between laser 120 and scanning system 130.

Laser 120 may be a pulsed laser or a continuous-wave (CW) laser capable of generating a pulsed or continuous laser beam 122. In an example, laser 120 is a pulsed laser capable of generating laser beam 122 comprising short (e.g., 10 to 15 picoseconds) high-energy (e.g., 30 μJ) optical pulses at relatively high repetition rates (e.g., up to 1 MHz). New advanced diode-pumped solid state lasers designed for industrial micro-processing and micro-machining are suitable for use as laser 120. Example wavelengths for laser 120 range from the ultraviolet to the infrared (e.g., 266 nm to 1064 nm). In an example, the laser beam optical pulses have an energy density equal to or greater than the wavelength-dependent ablation threshold of the particular substrate material used, which threshold is typically about 7 J/cm². An exemplary laser 120 includes the Lumera Super Rapid, available from Lumera Laser GmbH, Kaiserslautern, Germany.

An example scanning system 130 includes a two-axis galvo-driven mirror system that can rapidly scan laser beam 122 over a wide range of scanning angles. An example scanning lens 140 is an F-theta lens that provides a normally incident ablation beam 122 to substrate surface 12 regardless of the scanning angle. In an example, substrate stage 150 is configured to move substrate 10 in three directions, and also optionally move rotationally. Movement in the Z-direction allows for defocusing laser beam 122, and this type of defocusing can be used to tailor the shape of the substrate surface during the laser ablation process, as discussed below. Thus, laser beam 122 can be scanned over substrate surface 12 by the action of scanning system 130 (i.e., by moving the laser beam), by moving substrate stage 150, or a combination thereof. Typical scanning speeds are tens of millimeters per second, but can range up to about 1 m/s.

The main operating variables for system 100 include the laser pulse repetition rate, the energy density, the wavelength, and the scanning speed of laser beam 122. Example laser parameters are λ=1064 nm@ 6.9 watts output measured@ 100 kHz, which produces a pulse energy of 69 μJ/pulse. An example scanning lens 140 has an effective focal length of about 100 mm with a spot size of about 25 microns having an associated energy density of about 14 J/cm².

In an example, controller 170 is or includes a computer such as a windows-based personal computer having a processor 172 and a memory 174. Memory 174 constitutes a computer-readable medium for storing instructions that direct controller 170 (via processor 172) to control the operation of system 100 as described below.

### Forming the Superoleophobic Substrate

In the general operation of system 100, controller 170 sends a control signal S1 to laser 120 to initiate the creation of laser beam 122. Laser beam 122 is directed by optional fold mirrors FM1 and FM2 (and through optional magnifying lens 160, if present) to scanning system 130. Controller also sends a control signal S2 to scanning system 130 that causes the scanning system to direct (e.g., deflect) laser beam 122 over an angular range. The deflected laser beam 122 is received by scanning lens 140, which directs and focuses the laser beam onto substrate surface 12, where a laser spot 124 is formed. The operation of scanning system 130 causes laser spot 124 to move over substrate surface 12, as indicated by arrow A1.

In an example, controller 170 also sends a control signal S3 to substrate stage 150 to cause the substrate stage to move substrate 10 to enhance the scanning process, or to move another portion of the substrate surface within the scanning range of laser spot 124. Movement of substrate stage 150 is indicated by arrow A2. In an example, system 100 has a working range 180 over which laser spot 124 can scan. In some instances, working range 180 may be smaller than the size of substrate surface 12, in which case substrate stage 150 is used to move different regions of the substrate into the working range as the substrate is processed.

An example laser spot 124 has a diameter of about twice the wavelength of the light source, e.g., about 20 microns for a nominally 10.6 micron wavelength infrared laser such as a CO₂ laser. However, a wide range of laser spot sizes (diameters) can be employed, with an example range being between about 20 microns and about 250 microns. The shape of laser spot 124 need not be round.

Controller 170 includes instructions (i.e., is programmed with instructions embodied in memory 174) that cause system 100 to rapidly and precisely move laser spot 124 over substrate surface 12 within working area 180, to synchronize the movement of the laser spot with the laser beam energy, to accurately position substrate 10 in the working area, and to control the delivered energy density to the substrate at either below or above the substrate ablation threshold.

The degree to which substrate surface 12 is ablated is a function of the energy of laser beam 122 and the scanning velocity of laser spot 124. In the case where laser beam 122 is formed by short optical pulses (e.g., ˜10 ps), the optical pulses can be considered as being instantaneous compared to the scanning speed of system 100. The laser pulse repetition rate can be varied, e.g., from 10 Khz to 1 Mhz, with corresponding changes in energy. As scanning system 130 deflects laser beam 122, the scanning velocity of laser spot 124 determines whether there is any overlap of laser spots between pulses. Generally, at least a portion of substrate surface 12 is laser ablated.

Table 1 below sets forth some example system parameters for system 10 and the corresponding stepping distances for laser spot 124.

TABLE 1
EXAMPLE STEPPING DISTANCES

| SCANNING SPEED | REPETITION RATE | STEPPING DISTANCE | |
|---|---|---|---|
| 10 mm/s | 100 kHz | 0.1 | micron |
| 100 mm/s | 100 kHz | 1 | micron |
| 100 mm/s | 10 kHz | 10 | microns |
| 100 mm/s | 1 kHz | 100 | micron |
| 1000 mm/s | 100 kHz | 10 | microns |

FIG. 10 illustrates three examples (EX1, EX2 and EX3) of laser spot scanning, where in the first example there is space between adjacent laser spots 24 (EX1), where in the second example adjacent laser spots touch one another (EX2), and where in the third example there is overlap between adjacent laser spots (EX3). For laser spots 124 with a diameter of 50 microns, a 0.1 micron stepping distance represents substantial overlap of adjacent laser spots, while the stepping distance of 100 microns represents a center-to-center spacing between adjacent laser spots equal to the twice the laser spot diameter.

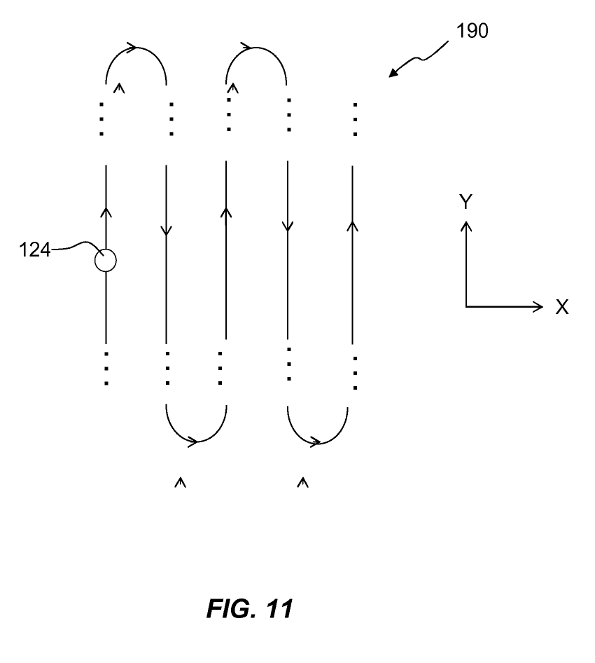

FIG. 11 illustrates an example scanning pattern 190 that generates Y-direction grooves that, along with X-direction grooves, define a grid-type interpillar spacing 136, as described below. Any type of scanning pattern for laser spot 124 may be used, such as raster, boustrophedonic, spiral, etc. An X-Y grid of grooves is formed, for example, by additionally performing the scanning pattern 190 of FIG. 11, but rotating it by 90° to form the X-direction grooves.

With continuing reference to FIG. 9 and also to FIG. 11, in an example controller 170 includes instructions (e.g., is programmed) to scan light spot 124 over substrate surface 10 to laser-ablate a select pattern 190 into at least a portion of the substrate surface. In practice, a variety of possible micropillar geometries can be formed in this manner based on different micropillar shapes (e.g., circular, oval, square, rectangular, triangular, polygonal, non-cylindrical, etc.), different interpillar spacings 36, and a variety of possible heights H. However, as discussed in detail below, micropillar array 30 represents an idealization of the actual micropillar array formed in substrate 10. In fact, in the present disclosure, if idealized micropillar array 30 is formed with high fidelity (e.g., clean, smooth sidewalls), it will not render substrate 10 superoleophobic when coated with a low-surface-energy coating. Micropillars 32 also need not be so regularly arranged as shown in FIG. 2, and aspects of the disclosure include randomly or quasi-randomly arranged micropillars.

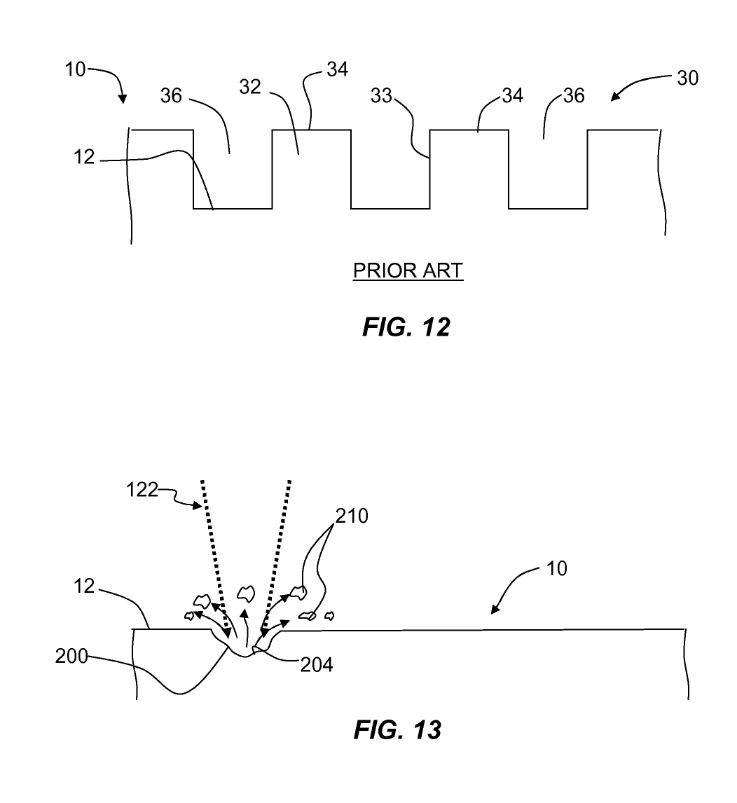

FIG. 12 is a close-up cross-sectional view of an comparative example of a micropillar array 30. Micropillar array 30 includes micropillars 32 having clean sidewalls 33 and flat (smooth) top surfaces 34. Clean and accurately reproduced micropillar arrays 30 such as shown in FIG. 12 can be formed using other microstructure fabrication methods, such as photolithography.

FIG. 13 is a close-up view of substrate 10 as laser ablation system 100 (FIG. 9) directs laser beam 122 to scan laser spot 124 over substrate surface 12 in a pattern 190 (FIG. 11) to start forming grooves 200 in the substrate surface. Groove 200 has an inner surface 204.

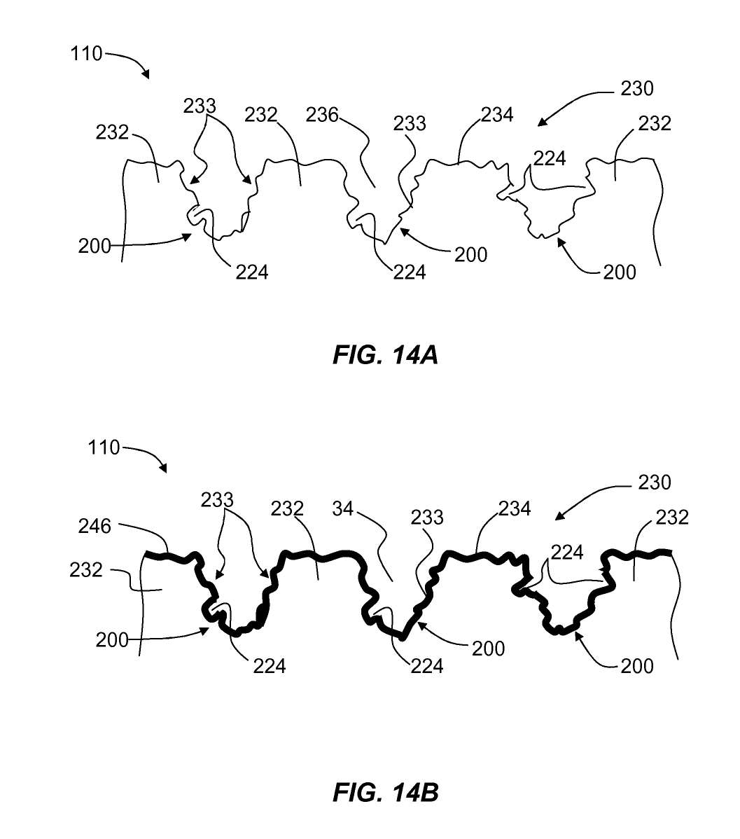

FIG. 14A is a schematic cross-sectional view of the actual micropillar array 230 with actual micropillars 232 formed in the superoleophobic substrate 110. Grooves 200 define an actual interpillar spacing 236, and actual micropillars 232 have sidewalls (surfaces) 233. With reference to FIG. 13, the initial groove 200 includes initial sidewalls 204. However, as shown in FIG. 14A, the laser ablation process can result in the formation of debris 210. In some cases, some of debris 210 is molten, and in some cases groove sidewalls 204 are heated to the point where they become molten and deformed.

With reference to FIG. 14B, formation of the final superoleophobic substrate 110 is accomplished by applying a low-surface-energy coating 246 to the substrate. Examples of such coatings include fluoropolymer, fluorosilane and combinations thereof.

Consequently, with reference again to FIG. 14A and FIG. 14B, the laser ablation process as practiced in the present disclosure does not replicate with high fidelity an ideal micropillar array 30. Nor does the laser ablation process as practiced herein involve substantial debris mitigation methods and apparatus, as is common in conventional laser ablation applications. Instead, the laser ablation process forms what would normally considered to be a non-ideal micropillar array 230 comprising non-ideal micropillars 232, wherein micropillar sidewalls (surfaces) 233 are deformed to the point where they irregularly roughened. In some cases, debris 210 deposits on and affixes to micropillar sidewalls 233 and tops 234, thereby contributing to the irregularly roughened sidewalls 233. Thus, the deposited debris 220, the sidewall surface deformation, or a combination thereof, define(s) irregularly roughened micropillar sidewalls (surfaces) 233.

In an example, roughened sidewalls (surfaces) 233 include pits 224 and bumps 226. Pits 224 form, for example, due to melting or other induced deformity of the sidewall, or by a collection of debris 220. Bumps 225 tend to form by debris sticking to micropillars 232. These surface features have superimposed micron and nanometer spatial scales (i.e., “microscale and nanoscale features”) that define a re-entrant micropillar geometry, which in turn yields the much-needed stability of the composite Cassie-Baxter state. Here, the term “microscale features” includes features such as pits and bumps having a size of about a micron to a few microns, and “nanoscale features” includes features that are less than about a micron down to about a nanometer.

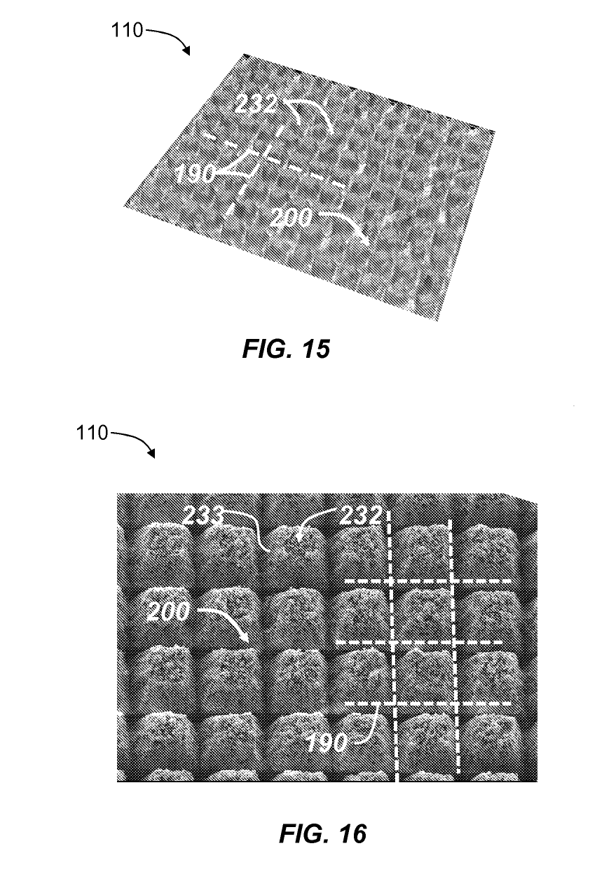

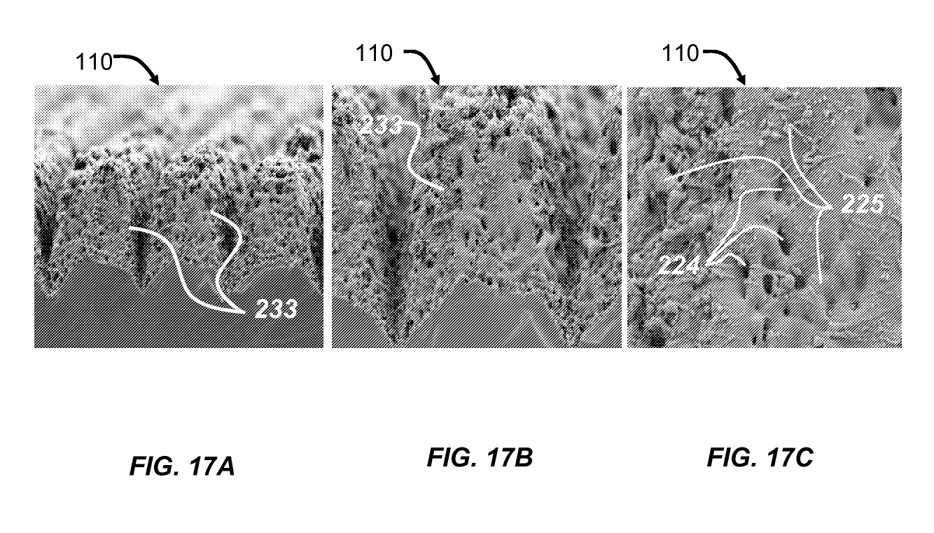

FIG. 15 and FIG. 16 are top-down perspective laser confocal microscope images of an example superoleophobic substrate 110 with micropillar array 230 formed via laser ablation as described above. FIG. 15 and FIG. 16 show a superimposed portion of the X-Y grid pattern 190 used to form grooves 200 of micropillar array 230. FIGS. 17A through 17C are cross-sectional close-up images of micropillars 232, with increasing magnification from FIG. 17A to FIG. 17C. The images show the irregular rough sidewalls (surfaces) 233 and top surfaces 234 formed on micropillars 232 by the laser ablation process. Pits 224 and bumps 225 are also identified in the images.

A number of substrates 110 with micropillar dimensions in the range from 20 microns to 50 microns were formed using the laser ablation process described above. The contact angles θ_{CW} and θ_{CO} for water and oil on these structures were measured after being coated with a low-surface-energy coating 246 in the form of DC2634. The water contact angle θ_{CW} on all substrates 110 was measured to be θ_{CW}˜180°, and water droplets disposed on substrate surface 50 rolled off the substrate without wetting the underlying bottom surface 12.

The oil contact angle θ_{CO} was also measured, and was found to be surprisingly high. The oil contact angle θ_{CW}˜75° on a flat surface coated with DC2604. However, for all of the substrates 110 fabricated as described above, the oil contact angle θ_{CW} was measured at θ_{CW}>140°, and for some substrate, θ_{CW}>150°, confirming the formation of superoleophobic substrates 110.

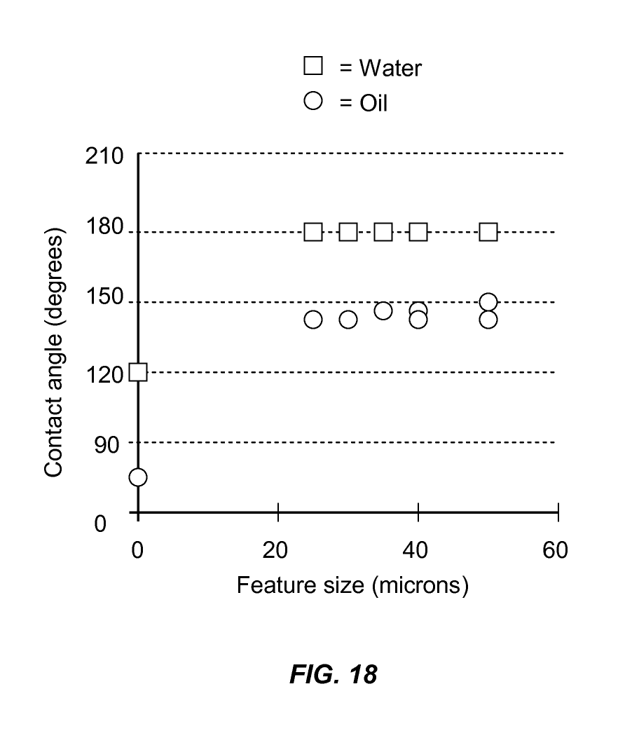

FIG. 18 plots the measured contact angles θ_{WC} and θ_{OC} for water and oil on the fabricated substrates 110 as a function of feature size (microns) after coating the substrate surface 50 with a low-surface-energy coating 246 in the form of fluorosilane (DC2634). The intrinsic contact angles θ_{CW} and θ_{CO} for water and oil on a flat substrate surface 12 coated with DC2634 are θ_{Wc}˜115° to 120° and θ_{CO}˜75° to 77°. However, the measured values of θ_{CW} and θ_{CO} for substrate 110 were θ_{CW}>170° for water and θ_{CO}>140° and often >150°. By tuning the micropillar array parameters a, b and H, the systems and methods of the disclosure can yield 115°≦θ_{CW}≦180° for water, and 75°≦θ_{CW}≦170° for oil. The data points for a feature size of 0 correspond to a flat surface.

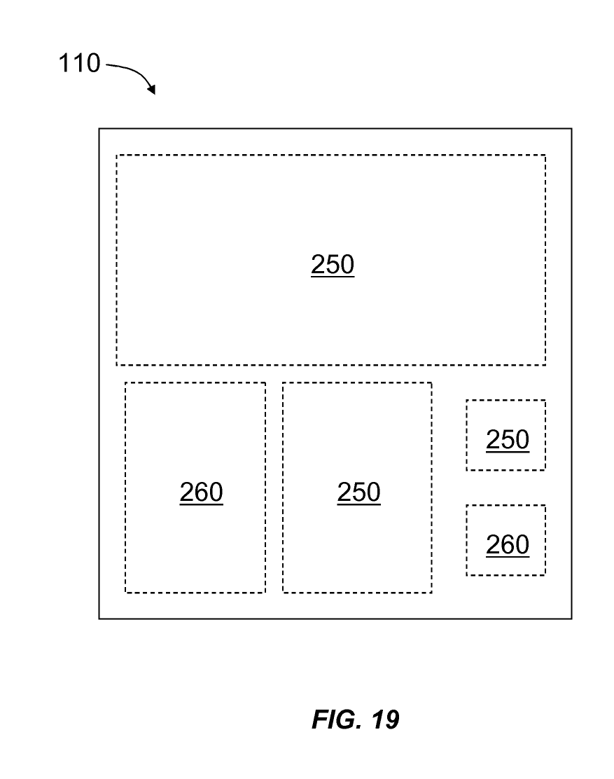

FIG. 19 is a top-down view of an example substrate 110 that includes at least one superoleophobic region 250 and at least one region 260 that is other than superoleophobic (e.g., hydrophobic, superhydrophobic, hydrophilic, superhydrophilic, and oleophilic). Such substrates can be used to form so-called “smart surfaces” with unique properties, such as transport (fluid flow, heat and mass transfer), reactive (kinetics and thermodynamics), nucleation, separation (separating a mixture into different streams) properties.

Potential applications of superoleophobic substrates 110 include micro-cavity arrays, micro-lens systems, life science cells, micro-reactor mixing design, touch screens and photovoltaic self-cleaning glass, to name a few.

The systems and methods of the disclosure provide design flexibility in that laser ablation can be used to form a wide variety of patterned features and surface textures. The systems and methods also allow for rapid prototyping and manufacturing, since superoleophobic substrates can be fabricated in a matter of minutes and in one or just a few steps.

While the disclosure has been described with respect to several preferred embodiments, various modifications and additions will become evident to persons of skill in the art. All such additions, variations and modifications are encompassed within the scope of the disclosure, which is limited only by the appended claims, and equivalents thereto.

What is claimed is:

1. A method of forming a superoleophobic surface, comprising:
providing a laser-ablatable substrate having a glass surface;
directing a laser beam to the substrate surface and laser-ablating at least a portion of the substrate surface to form an array of spaced-apart micropillars having sidewalls, wherein the laser beam has sufficient energy to form on the sidewalls an irregular rough surface with re-entrant microscale and nanoscale features that render the substrate surface superoleophobic when coated with a low-surface-energy coating; and
coating the substrate surface with the low-surface-energy coating.

2. The method of claim 1, further comprising:
generating debris from the laser-ablated portion of the substrate surface during the laser-ablating; and
allowing the debris to deposit on and affix to the micropillar sidewalls.

3. The method of claim 1, further comprising performing the laser ablating by irradiating the substrate surface with pulses of laser radiation.

4. The method of claim 3, further comprising:
directing the laser pulses to the substrate surface with a scanning mirror and an F-theta lens.

5. The method of claim 1, further comprising performing at least one of:
moving the laser beam; and
moving the substrate.

6. The method of claim 1, wherein the micropillars are not cylindrical.

7. The method of claim 1, wherein the superoleophobic substrate surface defines at least one of:
a water contact angle θ_{CW} for a water droplet such that 115°≦θhd CW≦180°; and
an oil contact angle θ_{CO} for an oil droplet such that 75°≦θ_{CO}≦180°.

8. The method of claim 1, wherein the micropillars do not have an overhang.

9. The method of claim 1, further comprising laser-ablating the substrate surface portion in a pattern that forms an X-Y grid of grooves in the substrate surface portion.

10. A method of converting a substrate surface to a superoleophobic substrate surface, comprising:
providing a substrate having the substrate surface, the substrate being formed from glass;
selecting a pattern for laser-ablating at least a portion of the substrate surface, wherein the pattern corresponds to an ideal array of micropillars that would not render the substrate surface superoleophobic when coated with a low-surface-energy coating;
laser-ablating the substrate surface in accordance with the selected pattern to form an actual array of micropillars having sidewalls while also generating debris from the laser-ablated substrate portion;
allowing the debris to deposit on and affix to the micropillars to form an actual array of micropillars having sidewalls with an irregular rough surface with re-entrant microscale and nanoscale features that render the substrate surface superoleophobic when coated with a low-surface-energy coating; and
coating the substrate surface with the low-surface-energy coating.

11. The method of claim 10, wherein the substrate surface defines an oil contact angle θ_{CO} for a drop of oil such that 75°≦θ_{CO}≦180°.

12. The method of claim 10, further comprising performing the laser ablating by irradiating the substrate surface with pulses of laser radiation.

13. The method of claim 12, further comprising at least one of:
scanning the laser pulses over the substrate surface using a scanning mirror and an F-theta lens; and
moving the substrate.

14. The method of claim 12, wherein the low-surface-energy coating comprises at least one of fluoropolymer and fluorosilane.

15. The method of claim 10, wherein the superoleophobic substrate surface further defines a water contact angle θ_{CW} such that 115°≦θ_{CW}≦180°.

16. A superoleophobic substrate, comprising:
a glass substrate having a surface;
a laser-ablated substrate portion comprising an array of spaced-apart micropillars formed in the surface and having sidewalls, the sidewalls having an irregular rough surface with re-entrant microscale and nanoscale features that render the substrate surface superoleophobic when the substrate surface is coated with a low-surface-energy coating; and
the low-surface-energy coating on the substrate surface.

17. The superoleophobic substrate of claim 16, wherein the irregular rough surface includes laser-ablation debris deposited on and affixed to the sidewalls.

18. The superoleophobic substrate of claim 16, wherein the superoleophobic substrate surface defines at least one of:
a water contact angle θ_{CW} for a water droplet such that 115°≦θ_{CW}≦180°; and
an oil contact angle θ_{CO} for an oil droplet such that 75°≦θ_{CO}≦170°.

19. The superoleophobic substrate of claim 16, wherein the low-surface-energy coating comprises at least one of fluoropolymer and fluorosilane.

20. The superoleophobic substrate claim 16, wherein the re-entrant microscale and nanoscale features includes bumps on and pits in the micropillar sidewalls.
